(19) United States
(12) Patent Application Publication
(10) Pub. No.: US 2007/0118795 A1
(43) Pub. Date: May 24, 2007

(54) A Method of Processing Annotations Using an Editable Multi-Dimensional Catalog

(76) Inventors: Peter Noyes, Pasadena, CA (US); Benjamin Gunderson, Simi Valley, CA (US)

Correspondence Address: STETINA BRUNDA GARRED & BRUCKER, 75 ENTERPRISE, SUITE 250, ALISO VIEJO, CA, 92656, US

(21) Appl. No.: 11/562,366

(22) Filed: Nov. 21, 2006

Related U.S. Application Data
(60) Provisional application No. 60/739,909, filed on Nov. 23, 2005.

(51) Int. Cl. G06F 17/00

(52) U.S. Cl. 715/512; 715/509

(57) ABSTRACT

A method of processing annotations is provided in accordance with an aspect of the present invention. The method includes the step of displaying in a workspace a document and a first visual representation of the annotations, which are defined by properties. The method includes the step of displaying in a markup window a catalog of the annotations that include values of the properties of the annotations. The method includes the step of sorting the catalog according to a chosen one of the properties. The method includes deriving a second visual representation of a first one of the annotations in response to an input modifying the value of a first one of the properties thereof in the catalog. The difference between the first of visual representation and the second visual representation of the first one of the annotations may be related to the first one of the properties.

### CROSS-REFERENCE TO RELATED APPLICATIONS

This application relates to and claims the benefit of U.S. Provisional Application No. 60/739,909 filed Nov. 23, 2005 and entitled “A SYSTEM AND METHOD FOR MANAGING, EDITING, AND VISUALIZING A MULTIDIMENSIONAL DATA SET IN A TABLE STRUCTURE WITH AN INDENTURED TREE LIST OF RELATED RECORDS” which is wholly incorporated by reference herein.

### STATEMENT RE: FEDERALLY SPONSORED RESEARCH/DEVELOPMENT

Not Applicable

### BACKGROUND

1. Technical Field

The present invention generally relates to methods of managing annotations linked to electronic documents with a graphical user interface, and more particularly, to methods of processing such annotations using editable multi-dimensional catalogs.

2. Related Art

With the advancement of high speed data communications, commerce and industry have come to rely upon the same to enable individuals in distant locations to collaborate. While real-time collaboration using videoconferencing and the like are becoming increasingly popular, the vast majority of collaboration occurs over e-mail with the exchange of documents incorporating incremental changes transmitted thereby. Due to the existence of many different computer platforms having a variety of operating systems, application programs, and processing and graphics display capabilities, it was appreciated by those in the art that a device-independent, resolution-independent file format was necessary to facilitate such exchange. In response to these needs, the Portable Document Format (PDF), amongst other competing formats, was developed.

The PDF standard is a combination of a number of technologies, including a simplified PostScript interpreter subsystem, a font embedding subsystem, and a storage subsystem. As practitioners in the art will recognize, PostScript is a page description language for generating the layout and the graphics of the document. Further, per the requirements of the PDF storage subsystem, all elements of the document, including text, vector graphics, and raster (bitmap) graphics, collectively referred to herein as graphic elements, are encapsulated into a single file. The graphic elements are not encoded to a specific operating system, software application, or hardware, but are designed to be rendered in the same manner regardless of destination or origin. The cross-platform capability of PDF aided in its widespread adoption, and is now a de facto standard for document exchange. Currently, PDF is utilized to encode a wide variety of documents types, including those largely composed of text and those largely composed of vector and raster graphics. Due to its versatility and universality, files in the PDF format are often preferred over more particularized file formats of specific word processing applications, illustration applications, CAD applications, and the like.

A number of useful improvements have been made since the initial releases of PDF readers, writers, and the standard itself. One improvement, particularly with regard to collaboration technologies, was the capability of adding annotations to a base document. For example, a local user created an initial version of the document, and transmitted it to distant colleagues. These remote users added their comments as annotations, and transmitted the newly annotated version of the document back to the local user. Upon making the changes as suggested by the colleagues, the local user again revised the document and transmitted the same back to the distant users. Other workflows were possible as well, such as where the base document ascends an organizational hierarchy, and the ascension of each organization level involving the addition of annotations by the recipients of the document. It is noted that PDF was not the only format incorporating collaboration features, and files generated by word processors such as the WORD application developed by Microsoft Corp. of Redmond, Wash., also included the capacity to add annotations and differentiate between original text and modified text of a document. However, the annotation capabilities related to PDF offered the greatest degree of flexibility because of the particulars relating to the structuring of the data.

In the course of these electronic document exchanges, it is understood that numerous annotations accumulate, leading to problems related to its management. The annotations and the document are typically rendered on a primary window, and so the numerous annotations placed thereon often clutters the view, making it difficult to manage, track, and understand the annotations.

In response, a number of divergent solutions to this problem of “clutter” have been proposed. One contemplates listing all of the annotations linked to the document in a window apart from the primary window. The listing may be sorted in one of a number of ways, such as by annotation type, date, author, color, and so forth. After selecting an annotation on the list, the primary window may be refreshed with the view being focused on the annotation. While generally improving organization of the annotations, such conventional flat lists are deficient for managing a large number of annotations. Further, interactivity with each of the annotations in such listings was limited as modifications could not be made. The conventional listing was also deficient for collaborative environments, because it is difficult to discern the context of a particular annotation with respect to the other annotations. Another solution to the problem of clutter as particularly related to collaborative environments contemplates appending supplemental remarks to the annotation in a nested manner, where remarks may be added in response to another comment. The annotations and the remarks related thereto may be listed in an indentured tree list, where the group of related comments is accessible. Such indentured tree lists are also deficient in that a large number of unrelated annotations are difficult to manage because of the inability to visualize the same at a higher level, and interactivity with the properties is limited.

Therefore, there is a need in the art for an improved method for efficiently organizing and managing a large number of annotations linked to a document. Specifically, there is a need in the art for a method of processing annotations to sort and group a listing of such annotations by the properties thereof. There is also a need for a method for handling edits to properties of annotations from an improved, tabular visualization of the annotations in a manner that such edits are immediately reflected in the visual representations. Further, there is a need for an improved method for organizing related annotations in a nested form, while sorting the listing of such annotations according to a selected one of the properties thereof.

### BRIEF SUMMARY

According to an aspect of the present invention, there is provided a method for processing annotations on the computer system having a graphical user interface, in which the annotation may be linked to a document. The method may also include the step of displaying in a workspace window the document and a first visual representation of the annotations. The annotations may be defined by properties. Further, the method may continue with displaying in a markup window a catalog of the annotations that may include values of the properties of the annotations. The method may also include the step of sorting the catalog according to a chosen one of the properties. Thereafter, the method may include the step of deriving a second visual representation of a first one of the annotations in response to an input modifying the value of a first one of the properties thereof in the catalog. The difference between the first visual representation and the second visual representation of the first one of the annotations may be related to the first one of the properties. The method may include the step of displaying in the workspace window the second visual representation of the first one of the annotations.

According to another aspect of the present invention, a first set of the properties may be appearance properties that relate to the visual representations of the annotation to which it relates. The catalog may be a table including a plurality of cells arranged in rows and columns. The cells in a given one of the rows may contain values of the properties that define a one of the annotations. The cells in a given one of the columns may contain values of a one of the properties that define each of the annotations. In any other aspect, the cell containing the value of the first one of the properties that is modified by the input may be a part of a first row of cells containing values of the properties that define the first one of the annotations. One of the properties may be an annotation descriptor, with the values being contained in the cells in a first column.

In yet another aspect of the present invention, there may be an inceptive annotation, where the method includes the step of receiving a supplemental entry that may be responsive to the inceptive annotation. The supplemental entry may include an entry descriptor. Further, according to such aspect, the method may also include the step of displaying the first entry descriptor in a cell in the first column. The entry descriptor may be indented from the inceptive annotation descriptor. Additionally, input operative to link the inceptive annotation to the document may be receivable from a first user, and input operative to link the supplemental entry to the inceptive annotation may be receivable from a second user. The method of processing annotations may also include the step of grouping the inceptive annotation descriptor with a plurality of the supplemental entries link thereto.

According to yet another aspect of the present invention, the rows of the table may be sorted according to the chosen one of the properties. The columns of the table may include headers corresponding to each of the properties that define the annotations. The rows of the table may be sorted in response to an input representative of a selection of the chosen one of the properties through the corresponding header. The method may also include the step of grouping the rows of the table according to the chosen one of the properties into sets of related rows. Further, the method may include the step of generating a grouping header in the table for each of the sets of the related rows. The grouping header may be representative of the chosen one of the properties.

According to another embodiment of the present invention, on the computer having a graphical user interface, there is provided a method for processing annotations associated with the document. The method begins with the step of displaying in a workspace window a visual representation of the document and of each of the annotations, as defined by properties thereof. The method may include the step of displaying in a markup window the table with a plurality of cells arranged in rows and columns. The properties of the annotations may be placed in the cells. Further there may be a step of altering the visual representation of a first annotation on the workspace window in response to an input modifying the first value contained in a first cell. The rule associated with the first cell may contain values of the properties that define the first annotation. The column associated with the first cell may contain values of the properties correlated to the altered visual representation of the first annotation.

The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of a system that may be used to implement aspects of the present invention, including a computer, a monitor, and various input devices;

FIG. 2 is a block diagram of the components of the computer in the system illustrated in FIG. 1;

FIG. 3 is an exemplary output of a computer program carrying out the method according to one aspect of the present invention including a workspace window and a markup window;

FIG. 4 is flowchart illustrating the steps of processing annotations in accordance with an aspect of the present invention;

FIG. 5 is a tree diagram illustrating properties that define the annotation;

FIG. 6 is a screen shot of the exemplary output with particular focus on a toolbar including icons associated therewith;

FIG. 7 is a screen shot of the exemplary output with the workspace window that illustrates the placement of an annotation on the workspace window;

FIG. 8 is a screen shot of the exemplary output showing the markup window including the table of cells arranged in rows and in columns in accordance with one aspect of the present invention;

FIG. 9 is a screen shot of the markup window with the rows of the table being grouped in an alternative manner, and showing only a subject column and an author column;

FIG. 10 is a screen shot of the markup window showing a first visual representation of an annotation;

FIG. 11 is a screen shot of one row of the table with the properties of the annotation;

FIG. 12 is a screen shot of the one row of the table after one of the properties of the annotation has been modified;

FIG. 13 is a screen shot of the markup window showing a second visual representation of the annotation after being modified via the table;

FIG. 14 is a block diagram illustrating the structure of supplemental entries in accordance with an aspect of the present invention; and

FIG. 15 is a screen shot of the markup window illustrating the implementation in the table of linking the supplemental entries to an inceptive annotation with only subject, author, and comment columns shown.

Common reference numerals are used throughout the drawings and the detailed description to indicate the same elements.

### DETAILED DESCRIPTION

The detailed description set forth below in connection with the appended drawings is intended as a description of the presently preferred embodiment of the invention, and is not intended to represent the only form in which the present invention may be constructed or utilized. The description sets forth the functions and the sequence of steps for developing and operating the invention in connection with the illustrated embodiment. It is to be understood, however, that the same or equivalent functions and sequences may be accomplished by different embodiments that are also intended to be encompassed within the spirit and scope of the invention. It is further understood that the use of relational terms such as first and second, top and bottom, and the like are used solely to distinguish one entity or step from another without necessarily requiring or implying any actual such relationship or order between such entities.

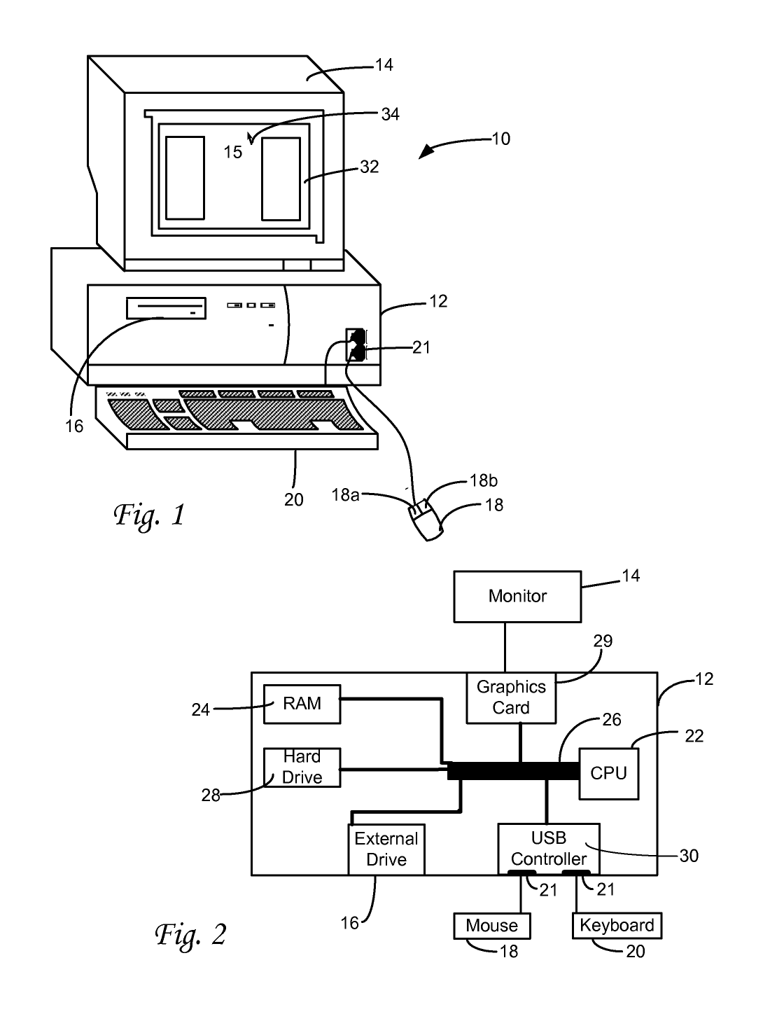

With reference now to FIG. 1, a system 10, an exemplary hardware environment upon which the present invention may be implemented, includes a computer 12 and a monitor 14. The monitor 14 graphically displays the output from the computer 12 through a screen 15, and may be a Cathode Ray Tube (CRT), a Liquid Crystal Display (LCD), or any other suitable display. An external drive 16 may also be included and accessible from the exterior of the computer 12, as well as any number of input devices such as a mouse 18 and a keyboard 20. The external drive 16 may be access data stored on a magnetic, optical, magneto-optical, tape or other type of machine-readable medium, such as a Compact Disc (CD), Digital Versatile Disc (DVD), and so forth. Further, additional input devices such as a graphical tablet (not shown) may also be attached to the computer 12. Typically, such input devices are connected to the computer 12 through a USB port 21, though alternative interconnection modalities such as a PS/2 port or a RS-232 serial port are also contemplated.

As further detailed in FIG. 2, the computer 12 includes a central processor 22, which may represent one or more conventional types of such processors, such as an IBM PowerPC processor, an Intel Pentium (or x86) processor, and so forth. A random access memory 24 is coupled to the central processor 20 via a bus 26. The memory 24 may be a dynamic random access memory (DRAM) and/or static RAM (SRAM), and serves as a temporary data storage area. The bus 26 further couples the central processor 22 to a secondary data storage unit 28, which is typically a hard disk drive, and the external drive 16. A graphics card 29 is also connected to the central processor 22 via the bus 26, and transmits signals representative of display data to the monitor 14. As briefly described above, the mouse 18 and the keyboard 20 are connected to the computer 12 over the USB connector 21. A USB host controller 30 serves as an intermediary between the mouse 18 and the keyboard 20 and the central processor 22. Specifically, the USB host controller 30 receives input from the mouse 18 and/or the keyboard 20 and is translated in such a manner that the central processor 22 can interpret the input. In some instances, the central processor 22 may transmit instructions to the USB host controller 30 to direct the operation of any peripherals attached to the USB port 21. As one of ordinary skill in the art will appreciate, additional devices such as printers, scanners, microphones, speakers, and the like may be connected to the computer 12 over the USB host controller 30 via the USB port 21 to provide more functionality.

The system 10 may utilize any operating system having a graphical user interface (GUI), such as MICROSOFT WINDOWS®, APPLE MACOS®, UNIX operating systems utilizing X Windows, and so forth. The computer 12 executes one or more computer programs, and as shown in FIG. 1, a resulting output 32 of such computer program may be displayed as “windows” or screen interfaces on the screen 15. Generally, the operating system and the computer programs are tangibly embodied in a computer-readable medium, e.g. one or more of the fixed and or removable data storage devices including the secondary data storage unit 28 or removable media read by the external drive 16. Both the operating system and the computer programs may be loaded from the aforementioned data storage devices into the memory 24 for execution by the central processor 22. The computer programs comprise instructions which, when read and executed by the central processor 22, cause the same to perform the steps necessary to execute the steps or features of the present invention.

According to one embodiment of the present invention, a user can interact with the system 10, specifically with the graphics being displayed on the screen 15, via the mouse 18. The movement of a cursor 34 is tied to the movement of the mouse 18, with further interactivity being provided with input from left and right mouse buttons 18a and 18b. Input from the keyboard 20 may also provide additional interactivity with the system 10, and in particular, the graphics displayed on the screen 15. The following description refers to “clicking” the left and right mouse buttons 18a, 18b, “positioning” the cursor 34 within the screen 14, and so forth, and it will be appreciated by those of ordinary skill in the art that such terms may also refer to any similar user interactions with the system 10 through a graphical user interface. The graphics displayed on the screen 15 may include various active segments, to which the cursor 34 may be navigated via the mouse 18. The mouse buttons 18a, 18b may then be clicked to initiate some data processing operation represented by the particular active segment.

The system 10 described above represents only one example of an apparatus that is suitable for implementing aspects of the present invention. As such, the system 10 may have many different configurations and architectures. Any such configuration and architecture may be readily substituted without departing from the scope of the present invention.

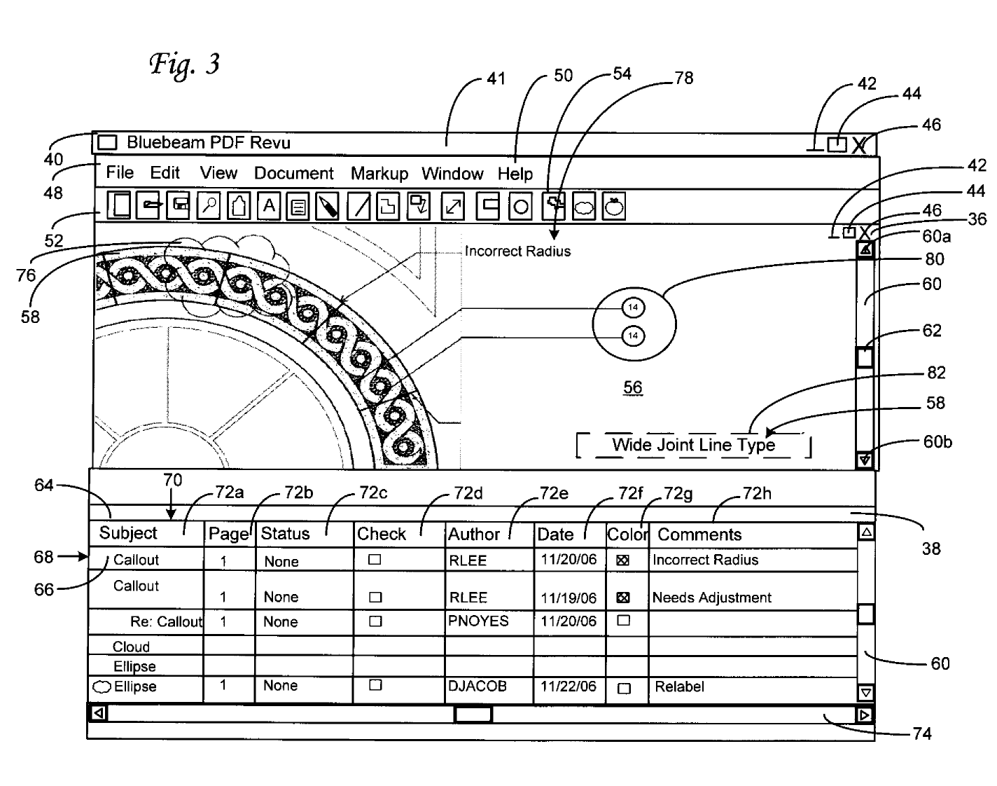

With reference now to FIG. 3, the output 32 of a computer program embodying one aspect of one embodiment of the present invention includes a workspace window 36 and a markup window 38. The program runs in a graphical user interface with windowing capabilities, and as such, the output 32 includes a main program window 40 that encompasses the workspace window 36 and the markup window 38. The main program window 40 includes a title bar 41 with various windowing controls such as a minimize button 42, a maximize button 44, and a close button 46. Below the title bar 41 is a menu bar 48 with selectable items 50 that may include “File”, “Edit”, “View”, “Document”, “Markup”, “Window”, and “Help”. Clicking one of the items 50 is operative to generate a submenu with additional items that, when clicked, initiate some data processing operation. Those of ordinary skill in the art will be able to recognize the various functionalities that are typically accessible via the items 50 of the menu bar 48. The more commonly used functions, while also being accessible via the items 50 of the menu bar 48, are accessible via a tool bar 52. The tool bar 52 includes tool bar icons 54 that can be clicked to initiate the data processing operations particular to the one of the tool bar icons 54.

The workspace window 36 is a document 56 having various document elements 58. In one embodiment, the document 56 is structured in accordance with the PDF standard, but one of ordinary skill in the art will recognize that any document format or standard capable of appending additional data to a base document may be readily substituted without departing from the scope of the present invention. As explained in the background, the document elements 58 of the PDF document 56 may be text, vector graphics, or raster graphics. As used herein, the term “document elements” may refer to all such types of data. Depending on the encoding and structure within the document 56, the document elements 58 may or may not be editable from the workspace window 36. The workspace window 36 typically includes a vertical scroll bar 60 with up and down arrows 60a, 60b that can be clicked to move up or down, respectively, the focus of the document 56. Further, the vertical scroll bar 60 includes a slidable indicator 62, the relative position within the vertical scroll bar 60 being representative of the focus position of the document 56 relative to the remainder of the same. The workspace window 36 may also include windowing controls such as the minimize button 42, the maximize button 44, and the close button 46, which accordingly modify the workspace window 36 within the confines of the main program window 40.

The markup window 38 is typically rendered below the workspace window 36, and includes a table 64. The table 64 has multiple cells 66 arranged in rows 68 and in columns 70. Each of the columns 70 of the cells 66 includes column headers 72a-72h containing text descriptive of data stored in the particular one of the columns 70. Further details relating to the features and functionality of the markup window 38, including the table 64, will be described more fully below. Like the workspace window 36, the markup window 38 includes the vertical scroll bar 60. Further, the markup window 38 may include a horizontal scroll bar 74 with similar related parts and functionality as the vertical scroll bar 60.

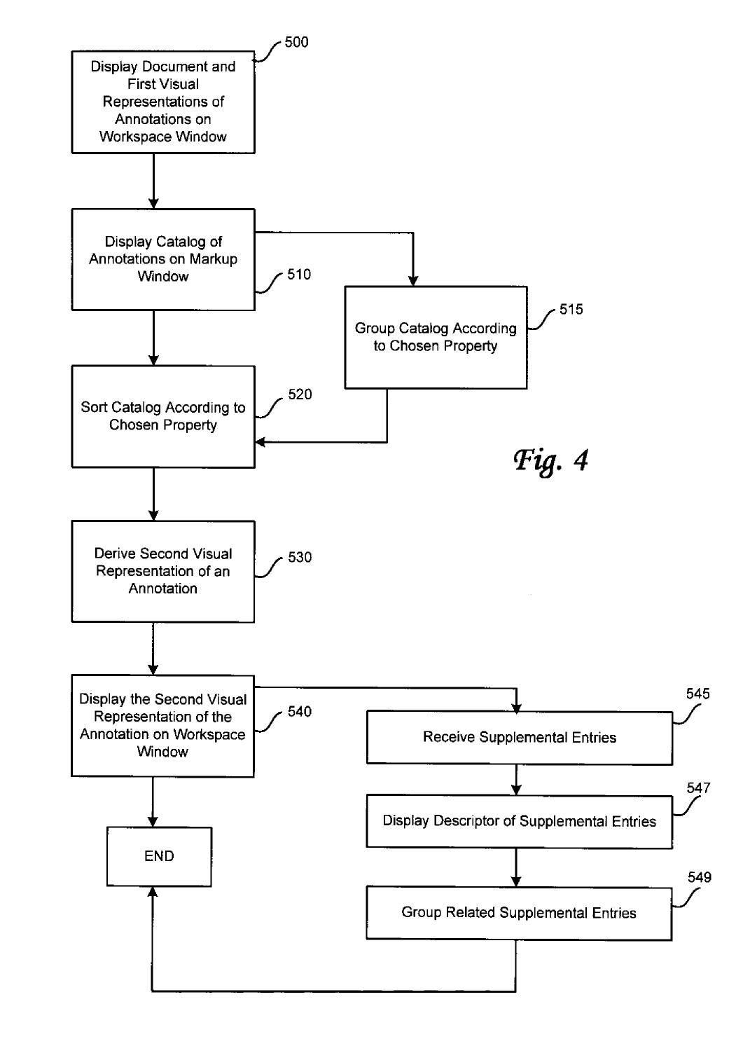

Having considered the generally pertinent features of the main program window 40, the workspace window 36, and the markup window 38, further details relating to the method for processing annotations on the system 10 will now be described. According to one aspect of the present invention, annotations are linked to and associated with the document 56. With reference to the flowchart of FIG. 4, the method for processing annotations begins with a step 500 of displaying in the workspace window 36 the document 56 and a first visual representation of the annotations. The annotations are overlaid on the document 56, and in the exemplary output 32, there is a first annotation 76, a second annotation 78, a third annotation 80, and a fourth annotation 82.

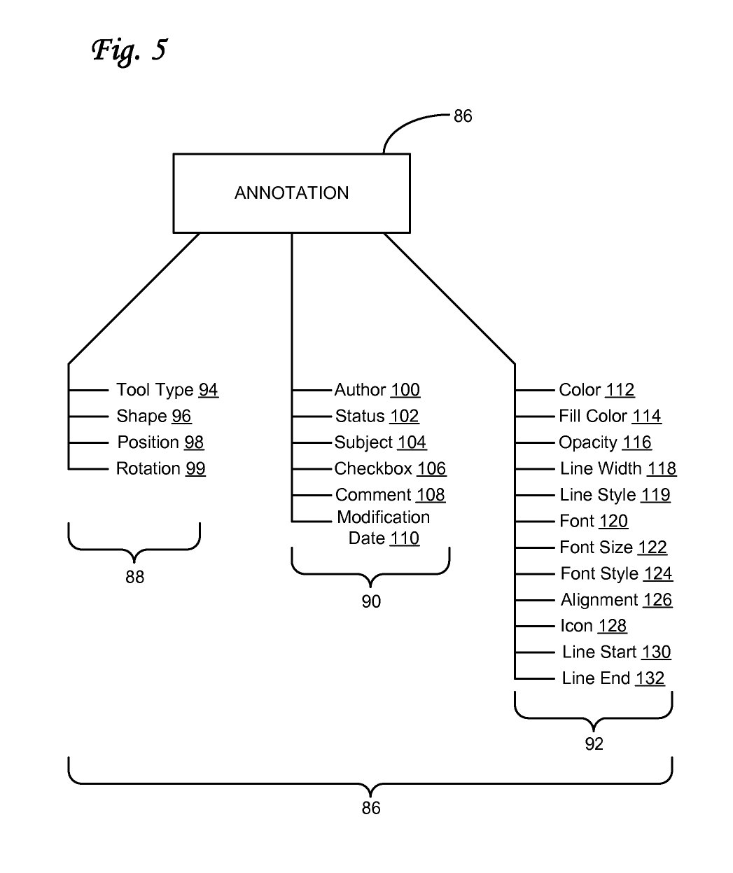

Referring to the data structure diagram of FIG. 5, in the abstract, an annotation 84 is a data object defined by one or more properties 86, with a value assigned thereto. Based on the properties 86, a visual representation of the annotation may be rendered on the workspace window 36. As will be appreciated by one of ordinary skill in the art, there are a variety of data structures that may be utilized to represent the annotation 84, including records with multiple fields, an array of data with particular elements holding particular properties, and so forth. The properties 86 may be further categorized into definitional types 88, general types 90, and appearance types 92. It is understood that the categories are presented for simplification purposes only, and are arbitrary in that such categories are not specifically identified.

Properties of the definitional type 88 include a tool type property 94, a shape property 96, a position property 98, and a rotation property 99. The tool type property 94 defines a type of the annotation 84, and provides the context in which the annotation 84 is rendered in the workspace window 36. As shown in FIG. 3, for example, the tool type property 94 may indicate that it is a cloud as is the case for the first annotation 76, or that it is a callout as is the case for the second annotation 78. Further, the tool type property 94 may indicate that it is an ellipse for the third annotation 80, or that it is a highlight, as is the case for the fourth annotation 82. It is to be understood that an annotation may be referred to by the value of the respective tool type property 94. For example, the first annotation 76 may be referred to as a cloud type annotation 76, the second annotation 78 may be referred to as a callout type annotation, and so forth. Additional values of the tool type property 94 are contemplated, such as free text, note, pen, line, dimension line, rectangle, polygon, and image. It will be appreciated that the values of the tool type property 94 previously mentioned is not intended to be exhaustive, and are presented by way of example only. Any other suitable annotation types may be included without departing from the scope of the present invention. The shape property 96 is the parameter by which the annotation 84 will be rendered on the workspace window 36, and includes values that define the points, lines, curves, and the like of the annotation 84. Depending on the value of the tool type property 94, the number of values in the shape property 96 may vary. Continuing with the example annotations placed on the document 56 in the output 32, the first annotation 76 may have shape property values that define a frame of multiple line segments. Further, the second annotation 78 may have shape property values that define the length of the two line segments, and the angle therebetween. The third annotation 80 may have shape property values that define the binding rectangle of the ellipse, while the fourth annotation 82 may define the stroke length of the highlight. The position property 98 defines the position of the annotation 84 in relation to the document 56 or the workspace window 36, and thus the value thereof include coordinates, page numbers, or a combination of the two. The rotation property 99 defines the rotation angle of the annotation 84 with respect to a reference axis.

The general type properties include an author property 100, a status property 102, a subject property 104, a checkbox property 106, a comment property 108, and a modification date property 110. The author property 100 defines the creator of the annotation 84. The default value of the author property 100 is the username associated with the system account utilized to create the annotation 84. The status property 102 has a finite list of values, including “accepted,” “rejected,” “cancelled,” and “completed,” but need not be limited to such values. The subject property 104 names the annotation 84, and multiple annotations may, and will typically have, the same subject property 104. The default value is equivalent to the value of the tool type property 94. Next, the checkbox property 106 is a Boolean value having a checked (on) state and an unchecked (off) state. Although a variety of uses for the checkbox property 106 are possible, a typical use is to determine whether the reviewer has examined the annotation 84. The comment property 108 contains text values which may or may not be displayed in the workspace window 36, depending upon the annotation type. For example, since the second annotation 78 is of a callout type and includes text content, the value of the comment property 108 is rendered in the workspace window 36. On the other hand, because the third annotation 80 is of the ellipse type and does not include text content, the value of the comment property 108 is not displayed. The value of the modification date property 110 represents the date and the time the annotation 84 was last edited. Editing includes the alteration of any of the properties of the annotation 84, including such modifications resulting from moving the annotation 84 within the workspace window 36.

The appearance type properties 92 generally relate to and further define the visual representations on the workspace window 36 of the annotation to which it pertains. These include a color property 112, a fill color property 114, an opacity property 116, a line width property 118, a line style property 119, a font property 120, a font size property 122, a font style property 124, an alignment property 126, an icon property 128, a line start property 130, and a line end property 132. It is contemplated that the color property 10 defines the color of all line segments of the annotation 84, while the fill color property 114 defines the color of any enclosed segments of the annotation 84. The opacity property 116 defines the level of opacity, or the degree of visibility provided through enclosed, filled areas of the annotation 84. Further, the line width property 118 defines the thickness of any line segments related to the annotation 84, while the line style property 119 indicates whether the line segments of the annotation 84 include gaps and if so, the size of such gaps. In other words, various dashed line styles may be specified with the line style property 119. The font property 120 defines the font in which to render any applicable text, the font size property 122 defines the size of such rendering, and the font style property 124 defines the bolding or italicizing of the rendered text. The alignment property 126 indicates whether applicable text is to be left justified, right justified, or centered. The icon property 128 defines a graphic placeholder of the annotation 84. The line start and line end properties 130 and 132 define the types of arrowheads appended to a line segment of the annotation 84. While all of the aforementioned properties of the definitional and general types 88 and 90 are associated with every annotation, not all properties of the appearance type 92 are so associated. For example, because there is no text being displayed with respect to the third annotation 80 as it is an ellipse type, it does not include the font property 120, the font size property 122, the font style property 124 or the alignment property 126. Other such examples exist, but will be readily determined without detailed explanations thereof by one of ordinary skill in the art.

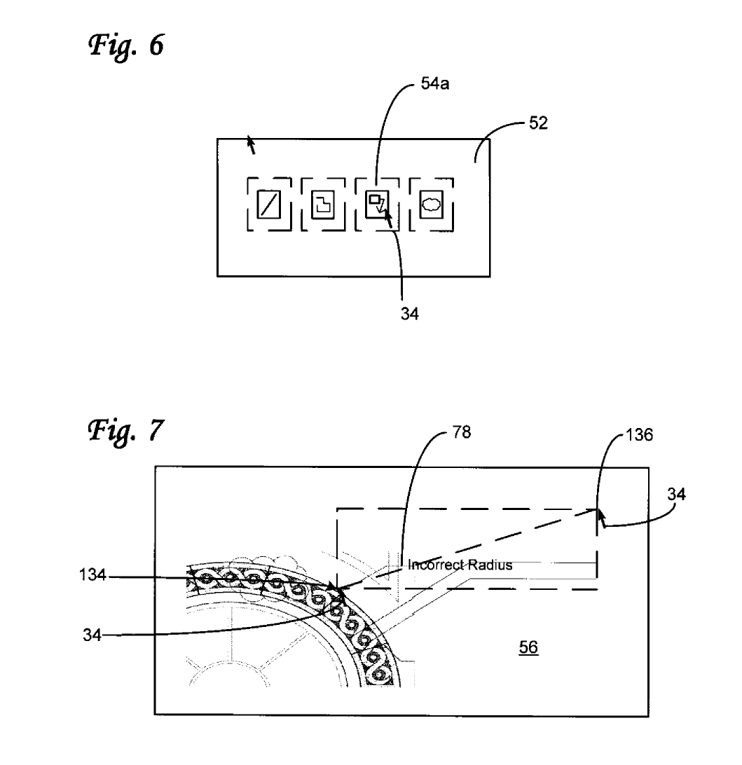

In one embodiment of the present invention, an annotation is placed on the document 56 by first selecting the annotation type, and then clicking and/or dragging the cursor 34 on the workspace window 36. For the example illustrated in FIGS. 6 and 7, the cursor 34 is navigated to the area of the toolbar 52 with a callout box icon 54a, and clicked. At this point, the annotation type tool is said to be selected. Thereafter, the cursor 34 is navigated to a desired starting point 134, clicked, dragged to a desired ending point 136, and released, placing the second annotation 76 with particular dimensions as shown. Alternatively, the cursor 34 is navigated to the starting point 134, clicked, and released, placing the second annotation 76 with a default dimension. It will be appreciated that the above-described technique of adding annotations is equally applicable to the placement of the other annotations. It will be further appreciated that any other technique for placing annotations on the document 56 may be readily substituted without departing from the scope of the present invention.

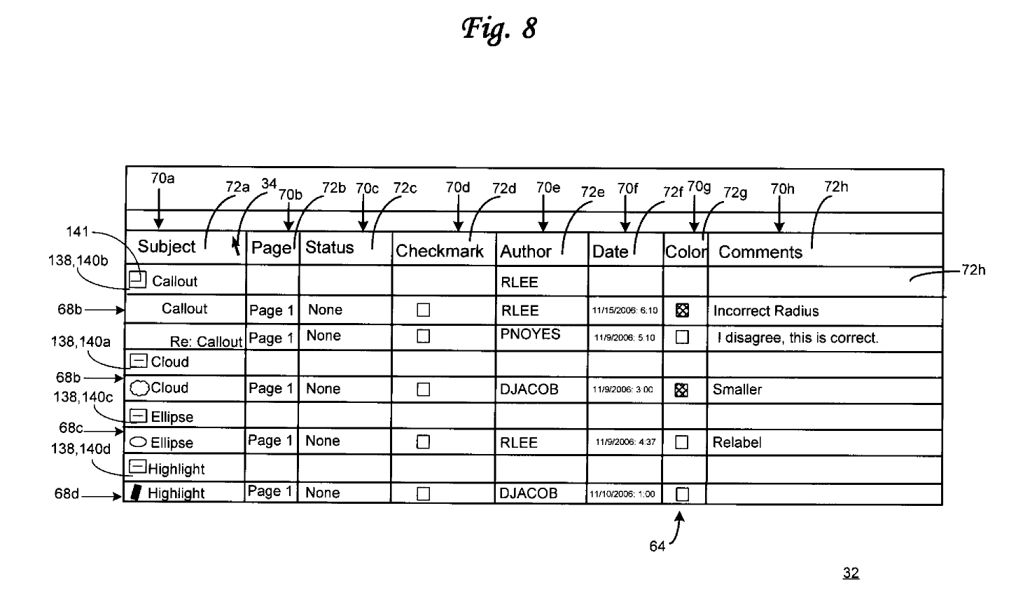

Referring back to the flowchart of FIG. 4, the method of processing annotations in accordance with one aspect of the present invention includes the step 510 of displaying in the markup window 38 on the graphical user interface a catalog of the annotations, including values of the properties 86 of the annotations. With further reference to FIG. 8, and as indicated above, the markup window includes the table 64 comprising the cells 66 arranged in the rows 68 and the columns 70. The cells 66 in a given one of the rows 68 contains values of the properties that define one of the annotations, and the cells 66 in a given one of the columns 70 contain values of a one of the properties 86 that define each of the annotations 84.

The cells are arranged to define columns 70a-70h, each corresponding to the column headers 72a-72h. As indicated above, the column headers 72a-72h contain text descriptive of data stored in the columns 70a-70h. According to another embodiment of the present invention, the column header 72a has a descriptor “Subject,” and the column 70a corresponding thereto contain values of the subject property 104 for each of the annotations linked to the document 56. The column header 72b has a descriptor “Page”, and the column 70b corresponding thereto contain values of the position property 98, and the column header 72c has a descriptor “Status” corresponding to the values of the status property 102 contained in the column 70c. The column header 72d has a descriptor “Checkmark” corresponding to the column 70d, which contains values of the check box property 106. Further, the column header 72e has a descriptor “Author”, and the column 70e corresponding thereto contains values of the author property 100. The column header 72f has a descriptor “Date” to correspond to the values of the modification date property 110 contained in the column 70f. The column header 72g includes a “Color” descriptor, and the column 70g corresponding thereto contains values of the color property 112. Finally, the column header 72h has a descriptor “Comments” to correspond to the values of the comment property 108 contained in the column 70h.

It will be appreciated by one of ordinary skill in the art that the arrangement of the columns 70a-h and of the corresponding column header 72a-h are presented by way of example only and not of limitation. Any other properties mentioned above may be included in another column of the table 64. Furthermore, it is expressly contemplated that an unlimited number of user-specified custom properties may be included as additional columns 70 in the table 64, each with corresponding column headers. In order to accommodate such additional columns, it is understood that other, non-relevant columns may be selectively hidden or shown. Along these lines, the size of the columns 70 may be adjusted by the user, and the order of the columns 70 may be re-arranged.

As described above, each of the rows 68a-d contain values of the properties 86 for a particular annotation 84. In one arrangement depicted in FIG. 8, the row 68a contains the properties 86 related to the first (cloud type) annotation 76, the row 68b contains the properties 86 related to the second (callout type) annotation 78, the row 68c contains the properties 86 related to the third (ellipse type) annotation 80, and the row 68d contains the properties 86 related to the fourth (highlight type) annotation 82. It is contemplated that upon placement of an annotation on the workspace window 36 as described above, the cells in one of the rows 68 is filled with the values of the properties 86 of the same. According to another aspect of the present invention, the method of processing annotations includes the step 520 of sorting the catalog or table 64, specifically the rows 68 thereof, according to a chosen one of the properties 86. In one embodiment, the cursor 34 may be navigated to one of the column headers 72a-h, and clicked to initiate the rearrangement of the vertical order of the rows 68. In other words, the sorting is performed in response to an input representative of a selection of a chosen one of the properties 86 through the corresponding one of the column headers 72a-h. As shown in the exemplary output 32, the table 64 may be sorted according to the subject property 104 by clicking on the column header 72a. Clicking on the column header 72a a second time is understood to effectuate the sorting of the rows 68 in reverse order.

In accordance with another aspect of the present invention, the method of processing annotations may include an optional step 515 of grouping the rows 68 of the table 64 according to the chosen one of the properties 86 into sets of related rows, and generating a group header 138 for each of the sets of related rows. This grouping step may be initiated by clicking on one of the column headers 72a-h of the property 86 to group by. In one embodiment, the group header 138 is representative of the chosen one of the properties 86. In the example output shown in FIG. 8, the rows 68 are grouped according to the subject property 104. The row 68a that contains the properties 86 of the first annotation 76 is grouped under a first subject group header 140a, correspondingly labeled “Cloud.” The row 68b that contains the values of the properties 86 of the second annotation 78 is grouped under a second subject group header 140b labeled “Callout”, and the row 68c that contains values of the properties 86 of the third annotation 80 is grouped under a third subject group header 140c, labeled “Ellipse.” Additionally, the row 68d containing values of the properties 86 of the fourth annotation 82 are grouped under a fourth subject group header 140d, labeled “Highlight.” Each of the group headers 140a-d include an expand/contract button 141, which when clicked, hides or shows the rows 68 associated with grouping. To better visualize the relationship between the group headers 138 and the rows 68, the contents of the first column 70a of each of the rows 68a-d (the value of the subject property 104 of the first annotation 76, the second annotation 78, the third annotation 80, and the fourth annotation 82) are indented from the respective subject group headers 140a-d.

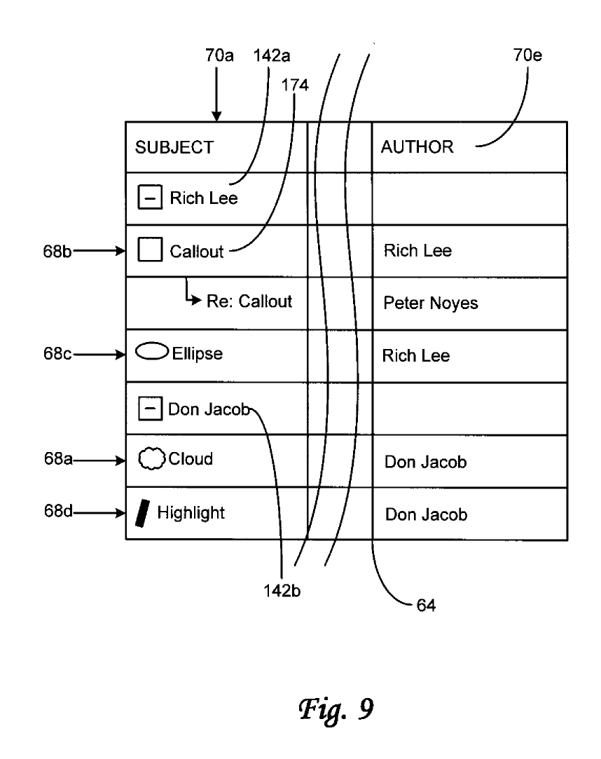

Referring to FIG. 9, the table 64 is illustrated with an alternative grouping by the author property 100. Because the author property 100 of the second annotation 78 and the third annotation 80 as shown in the second and third rows 68b, 68c, respectively is “Rich Lee”, those rows are grouped under a first author group header 142a accordingly labeled “Rich Lee.” Further, because the author property 100 of the first annotation 76 and the fourth annotation 82 as shown in the first and fourth rows 68a, 68d, respectively, is “Don Jacob”, those rows are grouped under a second author group header 142b accordingly labeled “Don Jacob.” It is understood that the first and second author group headers 142a, 142b are included within the first column 70a for improved visualization. As was the case for the grouping by the subject property 104 illustrated in FIG. 8 above, the contents of the first column 70a of each of the rows 68a-d (the value of the subject property 104 of the first annotation 76, the second annotation 78, the third annotation 80, and the fourth annotation 82) are indented from the respective author group headers 142a-d.

With reference back to the flowchart of FIG. 4, the method of processing annotations continues with a step 530 of deriving a second visual representation of a first one of the annotations in response to an input modifying a value of a first one of the properties thereof in the catalog or table 64. Further, the difference between such first visual representation and the second visual representation of the first one of the annotations is related to the first one of the properties. The method also includes a step 540 of displaying in the workspace window 36 the second visual representation of the first one of the annotations. More particularly, the cells 66 of the table 64 and the contents thereof are editable, and upon making the edits, such edits are reflected immediately on the corresponding annotation rendered on the workspace window 36.

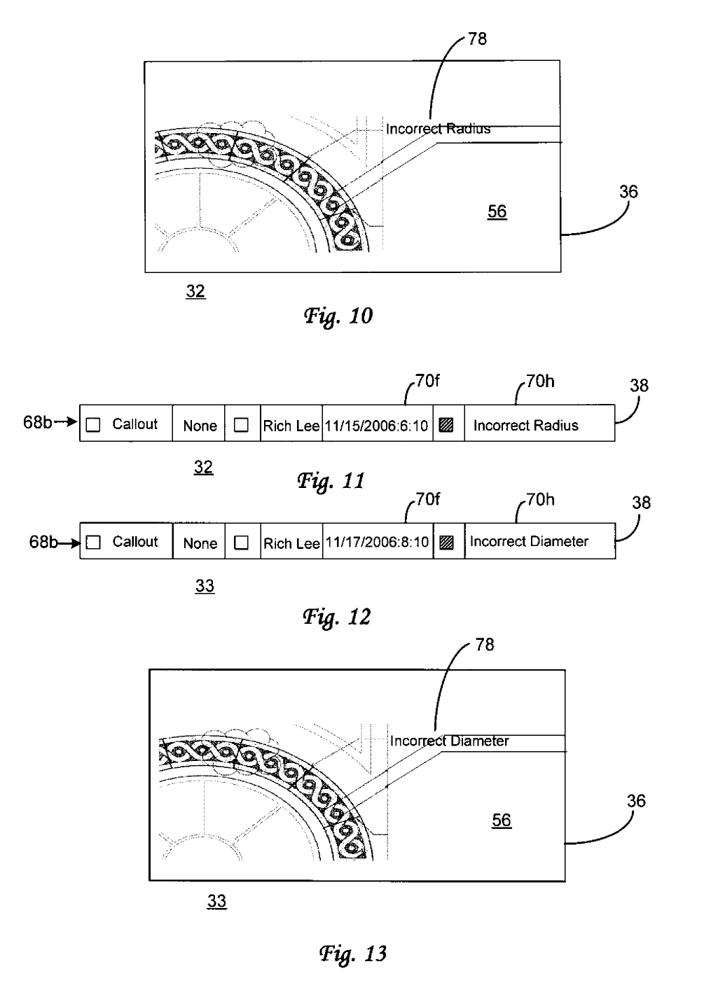

Referring to FIGS. 10 and 11, initially in the output 32, the second (callout type) annotation 78 is placed on the document 56 with both being displayed on the workspace window 36. As illustrated in the table 64, the comment cell 144, which is a part of the column 70h and the second row 68b, contains the value of the comment property 108 associated with the second annotation 78, that is, “Incorrect Radius.” The date cell 146, which is part of the column 70f and the second row 68b, contains a date of “Nov. 15, 2005.”

Referring to FIG. 12, in a subsequent output 33, the comment cell 144 is edited to read “Incorrect Diameter” instead. Upon making this edit, the date cell 146 is updated to “Nov. 17, 2005”, assuming that Nov. 17, 2005 is the date on which such edits were made. As shown in FIG. 13, the edit to the comment property 108 of the second annotation 78 in the foregoing manner is immediately reflected in the subsequent output 33 including the workspace window 36. Specifically, the second annotation 78 is rendered to include the modified text of “Incorrect Diameter.” Thus, the first visual representation of the second (callout type) annotation 78 is shown in the output 32, and after modifying the comment cell 144, the second visual representation of the annotation 78 is shown in the output 33. In other words, the visual representation of the second annotation 78 on the workspace window 36 is altered in response to an input modifying a value of the comment property 108 contained in the comment cell 144 associated with the table 64 on the markup window 38.

It is expressly contemplated that the above-described technique of modifying the visual appearance of an annotation on the workspace window 36 through changes made to the properties 86 through the cells 66 is not limited to the specific examples presented. Any one of the properties 86 may be edited via the table 66, on any of the annotations associated with the document 56. Additionally, it is also contemplated that the properties 86 of multiple annotations can be edited at once, by selecting each of the desired rows related to such annotations. By way of example only and not of limitation, multiple rows may be selected by clicking on each row with the shift key or control key depressed while doing so.

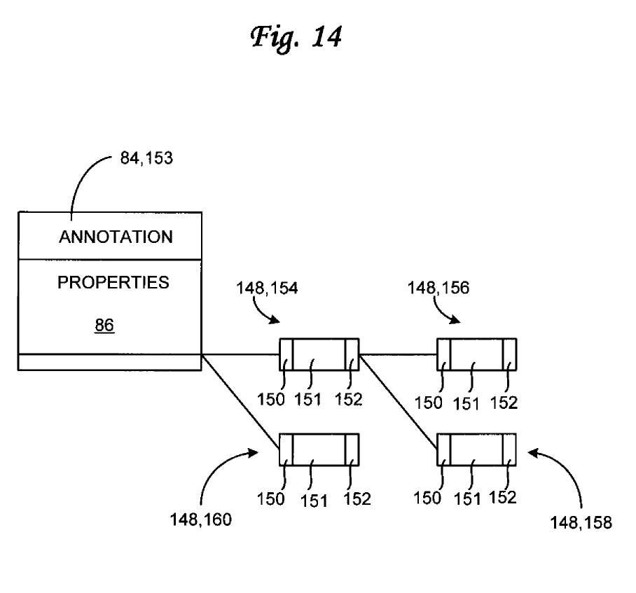

With reference again to the flowchart of FIG. 4, according to another aspect of the present invention, the method of processing annotations may also include an optional step 545 of receiving a supplemental entry responsive to an inceptive annotation. As indicated above and as shown in FIG. 14, the annotation 84 is defined by the properties 86, and may include one or more supplemental entries 148 linked to the annotation 84. Although any data structure may be utilized to implement the feature of the supplemental entries 148, it may be visualized as a linked list having a header 150 and a footer 152. The supplemental entries 148 may also include content data 151. More specifically, a first supplemental entry 154 may be linked to a second supplemental entry 156, the footer 152 of the first supplemental entry 154 pointing to the header 150 of the second supplemental entry 156. Additionally, the first supplemental entry 154 may be simultaneously linked to a third supplemental entry 158, where the footer 152 also points to the header 150 of the third supplemental entry 158. It is also contemplated that a fourth supplemental entry 160 may be linked to the annotation 84, in which the header 150 of the fourth supplemental entry 160 points to the annotation 84. It will be appreciated that any number of supplemental entries 148 may be linked in any fashion to another.

Generally, the feature of adding supplemental entries 148 is an application of the concept of threaded replies of messages from multiple users. For example, the first supplemental entry 154 and the fourth supplemental entry 156 may be a reply to the annotation 84, while second and third supplemental entries 156, 158 may be a reply to the first supplemental entry 154. In this regard, the annotation 84 may be more particularly referred to as an inceptive annotation 153 because the supplemental entries 152, 154, 156, and 158 are responsive thereto. The content data 151 includes textual comments like the values of the comment property 108 of the annotation 84, though any other data may be included.

With reference to FIG. 14, the supplemental entries 148 and the content data 151 as linked in the exemplary configuration above may also be represented in the table 64 as an indentured tree list. The inceptive annotation 153 and the values of the properties 86 thereof are contained in a first row 162. Specifically, an inceptive annotation descriptor 161 is disposed in the first column 70a, the author of the inceptive annotation 153 is “Rich Lee” as shown in the fifth column 70e, and the comment property 108 of the inceptive annotation 153 has the value of “Incorrect radius.” As indicated above, the first supplemental entry 154 is a reply to the inceptive annotation 153. A second row 164 contains a first entry descriptor 165, and a comment as shown in the column 70h stating “I disagree, this is the correct radius.” As shown in the column 70e, the author of the first supplemental entry 164 is “Peter Noyes”. It is understood that multiple users may thus exchange multiple supplemental entries 148.

To visually represent that the first supplemental entry 154 is nested under the inceptive annotation 153, the first entry descriptor 165 is indented relative to the inceptive annotation descriptor 161. A third row 166 contains a second entry descriptor 167, which is indented relative to the first entry descriptor 165 as a representation of the second supplemental entry 156 being nested, or a reply in response to, the first supplemental entry 154. A fourth row 168 contains a third entry descriptor 169 that is aligned with the second entry descriptor 167, since the second supplemental entry 156 and the third supplemental entry 158 are on the same level. Finally, a fifth row 170 contains a fourth entry descriptor 171 that is aligned with the first entry descriptor 165. It will be appreciated that the specific links between the various supplemental entries 148 are presented by way of example only and not of limitation, and any other arrangement, including multiple nesting levels, is possible.

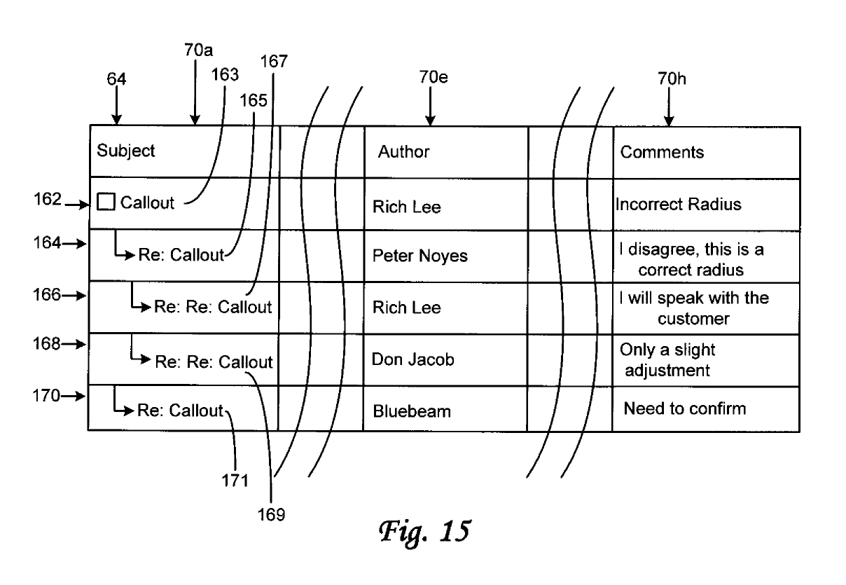

Referring again to the flowchart of FIG. 4, the method of processing annotations may also include yet another optional step 549 of grouping the inceptive annotation descriptor 161 with a plurality of the supplemental entries 148 linked thereto. As illustrated in FIG. 15, each of the first entry descriptor 165, the second entry descriptor 167, the third entry descriptor 169, and the fourth entry descriptor 171 are grouped under the inceptive annotation descriptor 161 because they are all related. In further detail, the second entry descriptor 167 and the third entry descriptor 169 are grouped under the first entry descriptor 165, because both the second supplemental entry 156 and the third supplemental entry 158 are replies to the first supplemental entry 154. Within each of the nested groupings, the arrangement of the respective rows may be according to the date/time in which a particular one of the supplemental entries 148 was added. Alternatively, the rows may be arranged alphabetically according to the first letter of the value of the comment property 108, or any other desirable manner.

In another embodiment as shown in FIG. 9, the above-described grouping of related supplemental entries 148 is maintained even where the table 64 is sorted in an alternative arrangement. More particularly, the second annotation 78 has an associated supplemental entry as represented by a supplemental entry descriptor 174. Although the table 64 is sorted according to the author property 100, the supplemental entry with the author property 100 thereof having a value of “Peter Noyes”, it is nevertheless grouped together under the first author group header 142, “Rich Lee”. Thus, it is possible to organize the view of all of the annotations 84 and the supplemental entries 148 in terms of replies and responses, as well as by related one of the properties 86.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

What is claimed is:

1. A method for processing annotations on a computer system having a graphical user interface, the annotations being linked to a document, the method comprising:
displaying in a workspace window on the graphical user interface the document and a first visual representation of the annotations, the annotations being defined by properties;
displaying in a markup window on the graphical user interface a catalog of the annotations including values of the properties of the annotations;
sorting the catalog according to a chosen one of the properties;
deriving a second visual representation of a first one of the annotations in response to an input modifying a value of a first one of the properties thereof in the catalog, a difference between the first visual representation and the second visual representation of the first one of the annotations being related to the first one of the properties; and
displaying in the workspace window the second visual representation of the first one of the annotations.

2. The method for processing annotations of claim 1, wherein a first set of the properties are appearance type properties that relate to the visual representations on the workspace window of the annotation to which it relates.

3. The method for processing annotations of claim 1, wherein the catalog is a table including a plurality of cells arranged in rows and in columns, the cells in a given one of the rows containing values of the properties that define a one of the annotations, and the cells in a given one of the columns containing values of a one of the properties that define each of the annotations.

4. The method for processing annotations of claim 3, wherein the cell containing the value of the first one of the properties modified by the input is part of a first row of cells containing values of the properties that define the first one of the annotations.

5. The method for processing annotations of claim 3, wherein one of the properties is an annotation descriptor, the values thereof being contained in the cells in a first column.

6. The method for processing annotations of claim 5, wherein the annotations include an inceptive annotation, the method further comprising:
receiving a supplemental entry responsive to the inceptive annotation, the supplemental entry including an entry descriptor; and
displaying in a cell in the first column the first entry descriptor, the entry descriptor being indented from the inceptive annotation descriptor.

7. The method for processing annotations as in claim 6, wherein input operative to link the inceptive annotation to the document is receivable from a first user, and input operative to link the supplemental entry to the inceptive annotation is receivable from a second user.

8. The method for processing annotations of claim 6, further comprising:
grouping the inceptive annotation descriptor with a plurality of the supplemental entries linked thereto.

9. The method for processing annotations as in claim 3, wherein the rows of the table are sorted according to the chosen one of the properties.

10. The method for processing annotations of claim 9, wherein the columns of the table include headers corresponding to each of the properties that define the annotations, the rows of the table being sorted in response to an input representative of a selection of the chosen one of the properties through the corresponding header.

11. The method for processing annotations of claim 9, further comprising:
grouping the rows of the table according to the chosen one of the properties into sets of related rows;
generating a grouping header in the table for each of the sets of related rows, the grouping header being representative of the chosen one of the properties.

12. An article of manufacture comprising a program storage medium readable by a computer, the medium tangibly embodying one or more programs of instructions executable by the computer to perform a method of processing annotations linked to a document, the method comprising:
displaying in a workspace window on the graphical user interface the document and a first visual representation of the annotations, the annotations being defined by properties;
displaying in a markup window on the graphical user interface a catalog of the annotations including values of the properties of the annotations;
sorting the catalog according to a chosen one of the properties;
deriving a second visual representation of a first one of the annotations in response to an input modifying a value of a first one of the properties thereof in the catalog, a difference between the first visual representation and the second visual representation of the first one of the annotations being related to the first one of the properties; and
displaying in the workspace window the second visual representation of the first one of the annotations.

13. The method for processing annotations of claim 12, wherein a first set of the properties are appearance type properties that relate to the visual representations on the workspace window of the annotation to which it relates.

14. The article of manufacture of claim 12, wherein the catalog is a table including a plurality of cells arranged in rows and in columns, the cells in a given one of the rows containing values of the properties that define a one of the annotations, and the cells in a given one of the columns containing values of a one of the properties that define each of the annotations.

15. The article of manufacture of claim 14, wherein the cell containing the value of the first one of the properties modified by the input is part of a first row of cells containing values of the properties that define the first one of the annotations.

16. The article of manufacture of claim 14, wherein one of the properties is an annotation descriptor, the values thereof being contained in the cells in a first column.

17. The article of manufacture of claim 16, wherein the annotations include an inceptive annotation, the method further comprising:
receiving a supplemental entry responsive to the inceptive annotation, the supplemental entry including an entry descriptor; and
displaying in a cell in the first column the first entry descriptor, the entry descriptor being indented from the inceptive annotation descriptor.

18. The method for processing annotations as in claim 17, wherein input operative to link the inceptive annotation to the document is receivable from a first user, and input operative to link the supplemental entry to the inceptive annotation is receivable from a second user.

19. The article of manufacture as in claim 17, the method further comprising:
grouping the inceptive annotation descriptor with a plurality of the supplemental entries linked thereto.

20. The article of manufacture as in claim 14, wherein the rows of the table are sorted according to the chosen one of the properties.

21. The article of manufacture as in claim 20, wherein the columns of the table include headers corresponding to each of the properties that define the annotations, the rows of the table being sorted in response to an input representative of a selection of the chosen one of the properties.

22. The article of manufacture as in claim 20, the method further comprising:
grouping the rows of the table according to the chosen one of the properties into sets of related rows;
generating a grouping header in the table for each of the sets of related rows, the grouping header being descriptive of the chosen one of the properties.

23. On a computer having a graphical user interface, a method for processing annotations associated with a document comprising:
displaying in a workspace window a visual representation of the document and of each of the annotations as defined by properties thereof;
displaying in a markup window a table with a plurality of cells arranged in rows and in columns, the properties of the annotations being placed in the cells; and
altering the visual representation of a first annotation on the workspace window in response to an input modifying a first value contained in a first cell;
wherein the row associated with the first cell contains values of the properties that define the first annotation and the column associated with the first cell contains values of the properties correlated to the altered visual representation of the first annotation.

24. The method for processing annotations as in claim 23, further comprising:
sorting the rows of the table according to a chosen one of the properties.

25. The method for processing annotations as in claim 23, wherein the columns of the table include headers corresponding to each of the properties, the rows of the table being sorted in response to an input representative of a selection of the chosen one of the properties.

26. The method for processing annotations as in claim 23, further comprising:
grouping the rows of the table according to the chosen one of the properties into sets of related rows;
generating a group header in the table for each of the sets of related rows, the grouping header being descriptive of the chosen one of the properties.
